(19) United States
(12) Patent Application Publication
(10) Pub. No.: US 2023/0278822 A1
(43) Pub. Date: Sep. 7, 2023

(54) A SYSTEM AND A METHOD FOR FORMING GLASS ROLLS

(71) Applicant: CORNING INCORPORATED, CORNING, NY (US)

(72) Inventors: EuiHo Kim, Asan-si (KR); Junwoo Kim, Asan-si (KR); Sue Camille Lewis, Webster, NY (US); Ki Chul Suh, Suwon (KR)

(21) Appl. No.: 18/015,466

(22) PCT Filed: Jul. 12, 2021
(86) PCT No.: PCT/US2021/041260

§ 371 Date: Jan. 10, 2023

(30) Foreign Application Priority Data
Jul. 17, 2020 (KR) 10-2020-0089169

(51) Int. Cl. B65H 23/195; C03B 33/023; C03B 40/00; C03B 33/09; B65H 23/032; B65H 23/04; B23K 26/38

(52) U.S. Cl. CPC B65H 23/1955; C03B 33/0235; C03B 40/005; C03B 33/091; B65H 23/0328; B65H 23/044; B65H 23/048; B23K 26/38; B65H 2301/4127; B23K 2103/54

(57) ABSTRACT

A system for forming glass rolls is provided. The system includes a glass ribbon supply system configured to supply a glass ribbon, a cutting system configured to cut the glass ribbon to a first portion and a second portion, a first glass winding system configured to wind the first portion of the glass ribbon to form a first glass roll, and a second glass winding system configured to wind the second portion of the glass ribbon to form a second glass roll.

### CROSS-REFERENCE TO RELATED APPLICATION

This application claims the benefit of priority under 35 U.S.C. § 371 of International Application No. PCT/US2021/041260, filed on Jul. 12, 2021, which claims the benefit of Korean Patent Application No. 10-2020-0089169, filed on Jul. 17, 2020, in the Korean Intellectual Property Office, the disclosure of which is incorporated herein in its entirety by reference.

### BACKGROUND

### 1. Field

The present disclosure relates to a system for and a method of forming glass rolls. More particularly, the present disclosure relates to a system for and a method of forming glass rolls having desired widths.

### 2. Description of the Related Art

Glass having a small thickness may be bendable and flexible. Bendable and flexible glass can be used for flexible displays, wearable electronic devices, and decorative materials for interior and exterior of buildings. Flexible glass may be wound into a roll and then may be stored and supplied in the form of a glass roll. A desired width of glass may vary according to the purpose of a final consumer. Accordingly, the development of a system for and a method of forming glass rolls having desired widths is needed.

### SUMMARY

The present disclosure provides a system for and a method of forming glass rolls having desired widths.

Additional aspects will be set forth in part in the description which follows and, in part, will be apparent from the description, or may be learned by practice of the presented embodiments of the present disclosure.

According to an aspect of the present disclosure, there is provided a system for forming glass rolls, the system including a glass ribbon supply system configured to supply a glass ribbon, a cutting system configured to cut the glass ribbon to a first portion and a second portion, a first glass winding system configured to wind the first portion of the glass ribbon to form a first glass roll, and a second glass winding system configured to wind the second portion of the glass ribbon to form a second glass roll.

According to some embodiments, the glass ribbon supply system may include a glass unwinder configured to unwind the glass ribbon from an initial glass roll.

According to some embodiments, the glass ribbon supply system may include a glass ribbon manufacturing system configured to manufacture the glass ribbon from a glass material.

According to some embodiments, the cutting system may include a laser configured to irradiate the glass ribbon.

According to some embodiments, the first glass winding system may include a glass winder configured to wind the first portion of the glass ribbon together with an interleaf to form the first glass roll, and an interleaf unwinder configured to supply the interleaf to the glass winder.

According to some embodiments, the first glass winding system may include a glass winder configured to wind the first portion of the glass ribbon to form the first glass roll, a position sensor configured to sense a position of the first portion of the glass ribbon, and a moving device configured to move the glass winder according to the position of the first portion of the glass ribbon.

According to some embodiments, the first glass winding system may include a first tension control system including a first tension sensor configured to sense a first tension of the first portion of the glass ribbon and a first tension controller configured to control the first tension according to the sensed first tension.

According to some embodiments, the first tension sensor may include a dancer roller, a swing arm attached to the dancer roller, and a swing arm position sensor configured to sense a position of the swing arm.

According to some embodiments, the first tension sensor may include a load cell roller.

According to some embodiments, the first tension controller may be configured to control a rotation speed of a glass winder according to the sensed first tension.

According to some embodiments, the first tension controller may be configured to control a force applying device configured to apply a force to a dancer roller according to the sensed first tension.

According to another aspect of the present disclosure, there is provided a system for forming glass rolls, the system including a glass ribbon supply system configured to supply a glass ribbon to a cutting zone, a cutting system configured to cut the glass ribbon to a first portion and a second portion in the cutting zone, an isolation roller configured to isolate a tension of the first portion of the glass ribbon in a first winding zone from a tension of the glass ribbon in the cutting zone, a first glass winding system including a first glass winder configured to wind the first portion of the glass ribbon in the first winding zone, and a first tension control system configured to control the tension of the first portion of the glass ribbon in the first winding zone, a second glass winding system configured to wind the second portion of the glass ribbon in a second winding zone; and a second tension control system configured to control a tension of the glass ribbon in the cutting zone.

According to some embodiments, the tension of the first portion of the glass ribbon in the first winding zone may be less than the tension of the glass ribbon in the cutting zone.

According to some embodiments, the second tension control system may be further configured to control a tension of the second portion of the glass ribbon in the second winding zone.

According to some embodiments, the system may further include a first guide roller configured to guide the first portion of the glass ribbon downwards, and a second guide roller configured to guide the second portion of the glass ribbon over the first glass winding system.

According to another aspect of the present disclosure, there is provided a method of forming glass rolls, the method including supplying a glass ribbon from a supply zone to a cutting zone, cutting the glass ribbon to a first portion and a second portion in the cutting zone, winding the first portion of the glass ribbon to form a first glass roll in a first winding zone, and winding the second portion of the glass ribbon to form a second glass roll in a second winding zone.

According to some embodiments, a width of the first portion of the glass ribbon may be greater than 50 mm and less than 320 mm.

According to some embodiments, a thickness of the glass ribbon may be 0.05 mm to 0.3 mm.

According to some embodiments, the winding of the first portion of the glass ribbon may be performed during the winding of the second portion of the glass ribbon.

According to some embodiments, the providing of the glass ribbon may include unwinding the glass ribbon from an initial glass roll.

According to some embodiments, the providing of the glass ribbon may include manufacturing the glass ribbon from a glass material.

According to some embodiments, the cutting of the glass ribbon may include irradiating a laser beam to a stationary position, and carrying the glass ribbon such that the glass ribbon passes through the stationary position.

According to some embodiments, the glass ribbon may be carried in a direction perpendicular to a width direction of the glass ribbon.

According to some embodiments, the method may further include sensing a position of the first portion of the glass ribbon during the winding of the first portion of the glass ribbon, and moving the first glass roll relative to the first portion of the glass ribbon according to the position of the first portion of the glass ribbon during the winding of the first portion of the glass ribbon.

According to some embodiments, the method may further include sensing a first tension of the first portion of the glass ribbon in the first winding zone, and controlling the first tension to be maintained within a predetermined range according to the sensed first tension.

According to some embodiments, the first tension may be maintained to be less than a second tension of the glass ribbon in the cutting zone.

According to some embodiments, the controlling of the first tension may include controlling a speed at which the first portion of the glass ribbon is wound according to the first tension.

According to some embodiments, the controlling of the first tension may include controlling a force that is applied to a dancer roller according to the sensed first tension.

According to some embodiments, the first tension may be isolated from a second tension of the glass ribbon in the cutting zone.

According to some embodiments, the method may further include sensing a second tension of the glass ribbon in the cutting zone, and controlling the second tension to be maintained within a predetermined range according to the sensed second tension.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a schematic view for explaining a system for and a method of forming glass rolls, according to an embodiment of the present disclosure;

FIG. 2 is a schematic view for explaining a system for and a method of forming glass rolls, according to an embodiment of the present disclosure;

FIG. 3 is a schematic view for explaining a first glass winding system included in a system for forming glass rolls according to an embodiment of the present disclosure and used in a method of forming glass rolls according to an embodiment of the present disclosure;

FIG. 4 is a schematic view for explaining a glass ribbon supply system included in a system for forming glass rolls according to an embodiment of the present disclosure and used in a method of forming glass rolls according to an embodiment of the present disclosure;

FIG. 5 is a schematic view for explaining a first tension control system included in a system for forming glass rolls according to an embodiment of the present disclosure and used in a method of forming glass rolls according to an embodiment of the present disclosure;

FIG. 6 is a schematic view for explaining a second tension control system included in a system for forming glass rolls according to an embodiment of the present disclosure and used in a method of forming glass rolls according to an embodiment of the present disclosure;

FIG. 7 is a schematic view for explaining a system for and a method of forming glass rolls, according to an embodiment of the present disclosure;

FIG. 8 is a schematic view for explaining a first tension control system included in a system for forming glass rolls according to an embodiment of the present disclosure and used in a method of forming glass rolls according to an embodiment of the present disclosure; and

FIG. 9 is a schematic view for explaining a second tension control system included in a system for forming glass rolls according to an embodiment of the present disclosure and used in a method of forming glass rolls according to an embodiment of the present disclosure.

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “one or more of,” when preceding a list of elements, modify the entire list of elements and do not modify the individual elements of the list.

Exemplary embodiments of the present disclosure will now be described more fully with reference to the accompanying drawings. The embodiments of the present disclosure may, however, be embodied in many different forms, and thus the scope of the present disclosure should not be construed as limited to the exemplary embodiments set forth herein. Embodiments of the present disclosure should be interpreted as being provided to explain the present disclosure in more detail to one of ordinary skill in the art. Like numbers refer to like elements throughout the specification. Various elements and regions illustrated in the drawings are schematic in nature. Thus, the present disclosure is not limited to relative sizes or distances illustrated in the accompanying drawings.

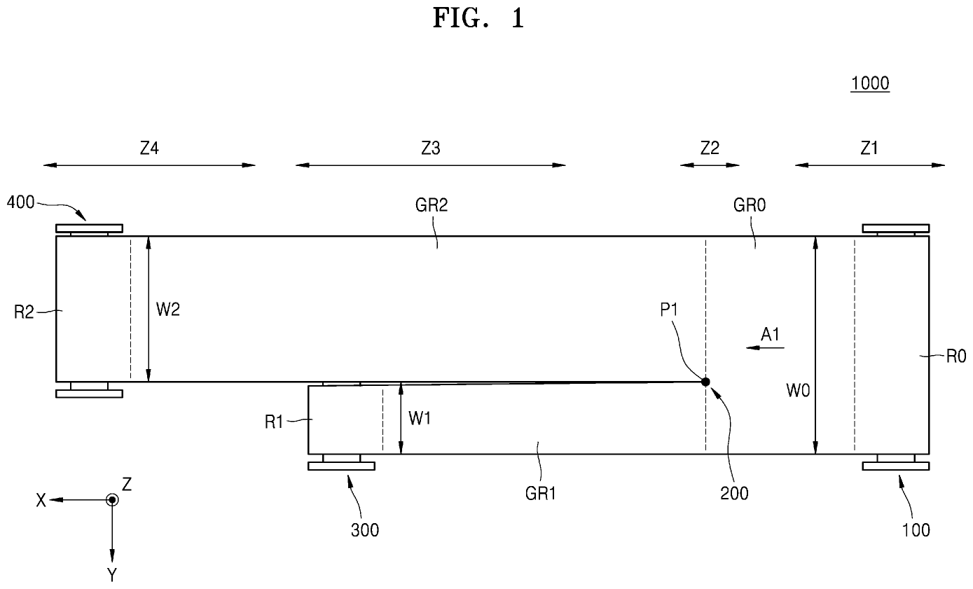

FIG. 1 is a schematic view for explaining a system 1000 for and a method of forming glass rolls R1 and R2, according to an embodiment of the present disclosure.

Referring to FIG. 1, the system 1000 for forming the glass rolls R1 and R2 may include a glass ribbon supply system 100, a cutting system 200, a first glass winding system 300, and a second glass winding system 400.

The glass ribbon supply system 100 may be configured to supply a glass ribbon GR0 from a supply zone Z1 to a cutting zone Z2. The glass ribbon GR0 may extend with a width W0 in a direction (i.e., an X direction) perpendicular to a direction (i.e., a Y direction) of the width W0. The width W0 of the glass ribbon GR0 may be, for example, about 100 mm to about 5,000 mm, for example, about 1,300 mm. The glass ribbon GR0 may have a thickness in a direction (i.e., a Z direction) perpendicular to the direction (i.e., the X direction), in which the glass ribbon GR0 extends, and the width direction (i.e., the Y direction). The thickness of the glass ribbon GR0 may be about 0.05 mm to about 0.3 mm, for example, about 0.05 mm to about 2.5 mm, about 0.05 mm to about 0.2 mm, about 0.05 mm to about 0.15 mm, about 0.05 mm to about 0.1 mm, about 0.1 mm to about 0.3 mm, about 0.15 mm to about 0.3 mm, or about 0.2 mm to about 0.3 mm. When the thickness of the glass ribbon GR0 is less than about 0.05 mm, the glass ribbon GR0 is too thin and light to be handled. On the other hand, when the thickness of the glass ribbon GR0 is greater than about 0.3 mm, the glass ribbon 220 is less flexible, and thus, it may be difficult to form the glass rolls R1 and R2. The glass ribbon GR0 may include, for example, silicate glass, borosilicate glass, aluminosilicate glass, boro aluminosilicate glass, or a combination thereof, each containing or not containing alkali element(s). The glass ribbon GR0 may be, for example, Willow® glass obtainable from Corning Incorporated.

According to some embodiments, the glass ribbon GR0 may be provided by unwinding an initial glass roll R0. For example, assuming that the glass ribbon GR0 is completely unwound from the initial glass roll R0, an overall length of the glass ribbon GR0 may be about 10 m to about 1,000 m, for example, about 300 m. When the glass ribbon GR0 is provided by unwinding the initial glass roll R0, a glass roll forming method according to the present disclosure may be a roll-to-roll process of forming the glass rolls R1 and R2 from the initial glass roll R0.

The glass ribbon GR0 may be supplied from the supply zone Z1 to the cutting zone Z2 in a conveying direction A1. The conveying direction A1 may be perpendicular to the direction (i.e., the Y direction) of the width W0 of the glass ribbon GR0. In other words, the conveying direction A1 may be parallel to the direction (i.e., the X direction) in which the glass ribbon GR0 extends. In the cutting zone Z2, the glass ribbon GR0 may be cut into a first portion GR1 and a second portion GR2 of a glass ribbon by the cutting system 200. For example, the cutting system 200 may irradiate a laser beam onto a stationary position P1, and the glass ribbon GR0 may be conveyed in the conveying direction A1 to pass through the stationary position P1.

The first portion GR1 and the second portion GR2 of the glass ribbon may become a first glass ribbon and a second glass ribbon, respectively. The first portion GR1 of the glass ribbon may have a first width W1 in the Y direction, and the second portion GR2 of the glass ribbon may have a second width W2 in the Y direction. The first width W1 of the first portion GR1 of the glass ribbon may be a width required for sale or usage. The first width W1 of the first portion GR1 of the glass ribbon may be less than a conventionally obtainable width (for example, about 320 mm). In the related art, when a glass ribbon is cut to a desired width, two cutting devices (for example, two laser beams) are used, and the glass ribbon cannot be cut to a smaller width than about 320 mm due to a limitation in a minimum distance between the two cutting devices. However, according to the present disclosure, a glass ribbon having a desired width may be obtained using only one laser, and thus, a glass ribbon with the first width W1, which is less than about 320 mm, may be obtained. However, when the first width W1 is 50 mm or less, the first portion GR1 is too light to be handled, and it may be difficult to form the first glass roll R1. Thus, according to some embodiments, the first width W1 of the first portion GR1 may be greater than about 50 mm and less than about 320 mm. For example, the first width W1 may be about 60 nm to about 300 nm, about 70 nm to about 300 nm, about 80 nm to about 300 nm, about 90 nm to about 300 nm, about 100 nm to about 300 nm, about 60 nm to about 250 nm, about 60 nm to about 200 nm, about 60 nm to about 150 nm, or about 60 nm to about 100 nm. The first width W1 of the first portion GR1 is not limited to being less than 320 mm. According to some embodiments, the first width W1 of the first portion GR1 may be about 320 mm or greater.

The second width W2 of the second portion GR2 of the glass ribbon may be greater than or equal to the first width W1 of the first portion GR1 of the glass ribbon. The second width W2 may be greater than about 50 mm. When the second width W2 is 50 mm or less, it may be difficult to handle the second portion GR2 and form the second glass roll R2.

In the related art, the width of a portion of the glass ribbon GR0 removable through one cutting is limited to about 300 mm. Accordingly, to remove a portion of glass ribbon having a greater width (for example, greater than 300 mm) and obtain a portion of a glass ribbon having smaller width, the glass ribbon GR0 needs to undergo a plurality of cutting operations, namely, a plurality of glass roll forming operations. However, according to the present disclosure, to obtain the first portion GR1 of the glass ribbon having a desired first width W1, a maximum second width W2 of the second portion GR2 of the glass ribbon that is separable from the glass ribbon GR0 may be greater than that in the related art (about 300 mm). Accordingly, to form the first glass roll R1 of the first portion GR1 of the glass ribbon having a narrow first width W1, only one glass roll forming process may be needed. Accordingly, due to the use of the method and the system according to the present disclosure, a production time and production costs may be greatly reduced, compared to the related art.

The first portion GR1 of the glass ribbon may be conveyed in the conveying direction A1 from the cutting zone Z2 to a first winding zone R3, and the second portion GR2 of the glass ribbon may be conveyed in the conveying direction A1 from the cutting zone Z2 to a second winding zone Z4. The first portion GR1 of the glass ribbon may be wound by the first glass winding system 300 to form the first glass roll R1 in the first winding zone Z3, and the second portion GR2 of the glass ribbon may be wound by the second glass winding system 400 to form the second glass roll R2 in the second winding zone Z4. According to some embodiments, the first portion GR1 of the glass ribbon may be wound while the second portion GR2 of the glass ribbon is being wound. In other words, the first glass roll R1 and the second glass roll R2 are not sequentially but simultaneously formed. Accordingly, the production time and production costs may be significantly reduced.

When the method and the system 1000 according to some embodiments of the present disclosure are used, the two glass rolls R1 and R2 may be formed from the single initial glass roll R0. Because the second portion GR2 is not discarded but is wound again on the second glass roll R2 while the first glass roll R1 is being formed, the second glass roll R2 may be again cut into a portion having a desired width and a remaining portion. Accordingly, the production costs may be greatly reduced compared with the related art where only a single glass roll is finally formed from the single glass ribbon GR0 and the remaining portions of the glass ribbon GR0 are discarded.

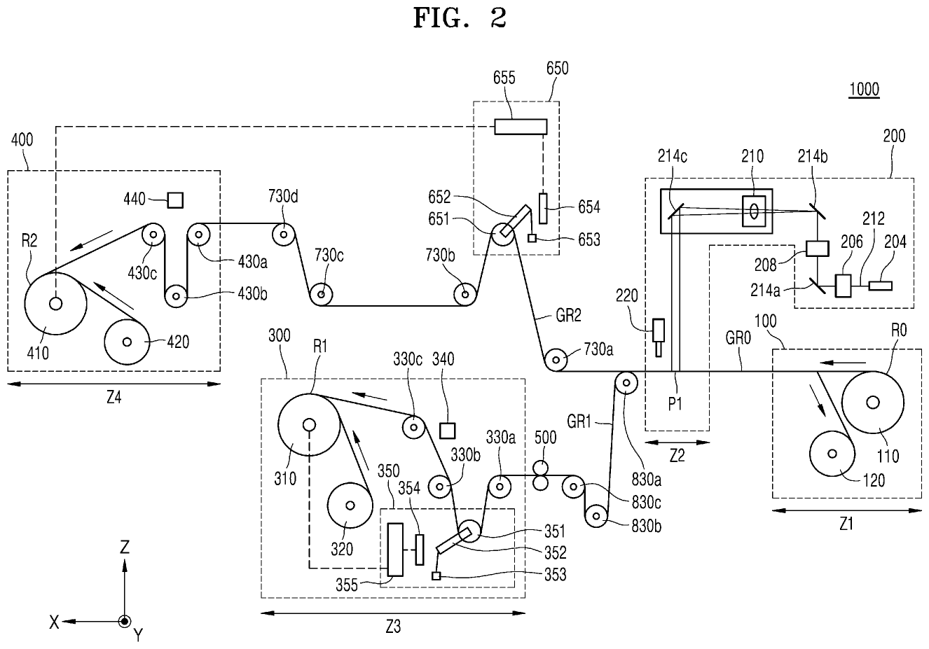

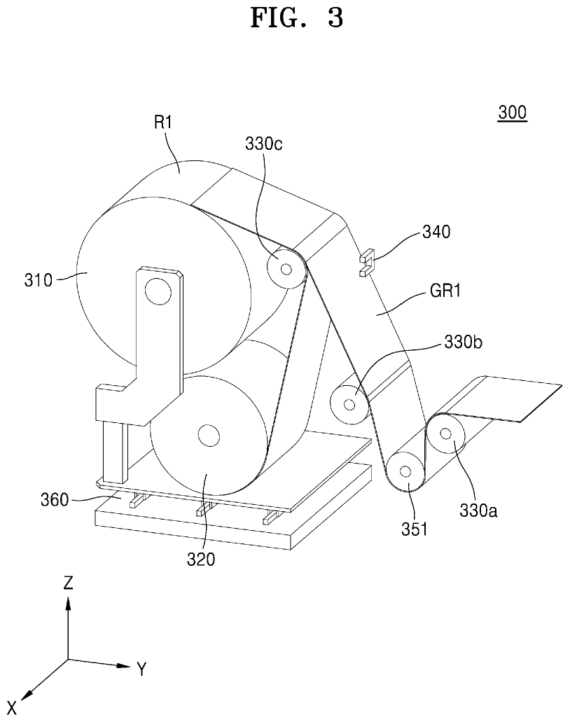

FIG. 2 is a schematic view for explaining the system 1000 for and the method of forming the glass rolls R1 and R2, according to an embodiment of the present disclosure. FIG. 3 is a schematic perspective view of the first glass winding system 300 included in the system 1000 for forming the glass rolls R1 and R2, according to an embodiment of the present disclosure, and used in the method of forming the glass rolls R1 and R2, according to an embodiment of the present disclosure.

Referring to FIGS. 2 and 3, the system 1000 for forming the glass rolls R1 and R2 may include the glass ribbon supply system 100, the cutting system 200, the first glass winding system 300, and the second glass winding system 400. The glass ribbon supply system 100 may be configured to provide the glass ribbon GR0 from the initial glass roll R0 in the supply zone Z1. For example, the glass ribbon supply system 100 may include a glass unwinder 110 configured to unwind the glass ribbon GR0 from the initial glass roll R0. The glass ribbon supply system 100 may further include an interleaf remover 120 (for example, an interleaf winder) configured to remove an interleaf from the initial glass roll R0.

The cutting system 200 may be configured to cut the glass ribbon GR0 into the first portion GR1 and the second portion GR2 in the cutting zone Z2. The cutting system 200 may include a laser 204 configured to irradiate and heat a portion of the glass ribbon GR0. The laser 204 may be, for example, a CO₂ laser. The laser 204 may be configured to generate a laser beam 212. According to some embodiments, the cutting system 200 may further include optical elements for deforming the laser beam 212. For example the cutting system 200 may further include a polarizer 206, a beam expander 208, and a beam shaping device 210. According to some embodiments, the cutting system 200 may further include optical elements, for example, mirrors 214a, 214b, and 214c, configured to redirect the laser beam 212 from the laser 204 to the glass ribbon GR0. According to some embodiments, the cutting system 200 may further include a cooling device 220 configured to cool a portion of the glass ribbon GR0 irradiated with and heated by the laser beam 212. The cooling device 220 may be configured to supply a cooling agent onto, for example, the heated portion of the glass ribbon GR0. The cooling agent may include a liquid, a vapor, or a combination thereof, for example, water.

The first portion GR1 of the glass ribbon separated in the cutting zone Z2 may be conveyed to the first winding system 300 in the first winding zone Z3, and the second portion GR2 of the glass ribbon separated in the cutting zone Z2 may be conveyed to the second winding system 400 in the second winding zone Z4. For example, the system 1000 according to an embodiment of the present disclosure may further include one or more first guide rollers 830a, 830b, and 830c configured to guide the first portion GR1 of the glass ribbon downwards and convey the first portion GR1 of the glass ribbon to the first winding system 300 in the first winding zone Z3, and one or more second guide rollers 730a, 730b, 730c, and 730d configured to guide the second portion GR2 of the glass ribbon upwards and convey the second portion GR2 of the glass ribbon to the second winding system 400 in the second winding zone Z4.

The first glass winding system 300 may include a first glass winder 310 configured to wind the first portion GR1 of the glass ribbon into the first glass roll R1. According to some embodiments, the first glass winding system 300 may further include a first interleaf unwinder 320 supplying an interleaf to the first glass winder 310. According to these embodiments, the first glass winder 310 may form the first glass roll R1 by winding the first portion GR1 of the glass ribbon and the interleaf together. According to some embodiments, the first glass winding system 300 may further include one or more guide rollers 330a, 330b, and 330c configured to guide the first portion GR1 of the glass ribbon to the first glass winder 310. The first portion GR1 of the glass ribbon conveyed to the first glass winder 310 by the one or more guide rollers 330a, 330b, and 330c may be wound on the first glass roll R1 by the first glass winder 310, together with the interleaf supplied by the first interleaf unwinder 320.

According to some embodiments, the first glass winding system 300 may further include a first position sensor 340 configured to sense a position of the first portion GR1 of the glass ribbon, and a moving device 360 of FIG. 3 configured to move the first glass winder 310 and the first interleaf unwinder 320 according to the position of the first portion GR1 of the glass ribbon. In FIG. 3, the first position sensor 340 includes an edge position control (EPC) sensor configured to sense a position of an edge of the first portion GR1 of the glass ribbon. However, according to another embodiment, a center position control (CPC) sensor may be used as the first position sensor 340. The moving device 360 may move the first glass winder 310 and the first interleaf unwinder 320 in the width direction (the X direction). The moving device 360 may include, for example, a linear motion (LM) guide movable in the width direction (the X direction). While the first glass winder 310 is winding the first portion GR1 of the glass ribbon, the first position sensor 340 may sense a position of the first portion GR1 of the glass ribbon that is provided to the first glass winder 310. The moving device 360 may appropriately move the first glass winder 310 and the first interleaf unwinder 320 such that the first portion GR1 of the glass ribbon is uniformly wound, namely, that both lateral sides of the first glass roll R1 are flat, while the first portion GR1 of the glass ribbon is being wound.

The second glass winding system 400 may include a second glass winder 410 configured to wind the second portion GR2 of the glass ribbon to form the second glass roll R2. According to some embodiments, the second glass winding system 400 may further include a second interleaf unwinder 420 configured to supply an interleaf to the second glass winder 410. According to these embodiments, the second glass winder 410 may form the second glass roll R2 by winding the first portion GR1 of the glass ribbon and the interleaf together. According to some embodiments, the second glass winding system 400 may further include one or more guide rollers 430a, 430b, and 430c configured to guide the second portion GR2 of the glass ribbon to the second glass winder 410. The second portion GR2 of the glass ribbon conveyed to the second glass winder 410 by the one or more guide rollers 430a, 430b, and 430c may be wound on the second glass roll R2 by the second glass winder 410, together with the interleaf supplied by the second interleaf unwinder 420.

According to some embodiments, the second glass winding system 400 may further include a second position sensor 440 configured to sense a position of the second portion GR2 of the glass ribbon, and a moving device (not shown) configured to move the second glass winder 410 and the second interleaf unwinder 420 according to the position of the second portion GR2 of the glass ribbon. The second location sensor 440 may be an EPC sensor or a CPC sensor. The moving device may include, for example, an LM guide. While the second glass winder 410 is winding the second portion GR2 of the glass ribbon, the second position sensor 440 may sense a position of the second portion GR2 of the glass ribbon that is provided to the second glass winder 410. The moving device may appropriately move the second glass winder 410 and the second interleaf unwinder 420 such that the second portion GR2 of the glass ribbon is uniformly wound, namely, that both lateral sides of the second glass roll R2 are flat, while the second portion GR2 of the glass ribbon is being wound.

According to some embodiments, the first glass winding system 300 may further include a first tension control system 350 configured to control a first tension of the first portion GR1 of the glass ribbon in the first winding zone Z3. The first tension control system 350 may maintain the first tension within a certain range. The first tension control system 350 may include a first tension sensor configured to sense the first tension of the first portion GR1 of the glass ribbon, and a first tension controller 355 configured to control the first tension according to the sensed first tension. According to some embodiments, the first tension sensor may include a dancer roller 351 movable in a vertical direction (Z direction) between the two guide rollers 330a and 330b, a swing arm 352 attached to the dancer roller 351, and a swing arm position sensor 354 configured to sense a position of the swing arm 352. The dancer roller 351 may move according to the first tension, and the swing arm 352 may rotate or move due to a movement of the dancer roller 351. The swing arm position sensor 354 may sense the first tension by sensing a rotation or movement of the swing arm 352. The first tension controller 355 may control a rotation speed of the first glass winder 310, namely, a speed at which the first portion GR1 of the glass ribbon is wound, according to the sensed first tension such that the rotation or movement of the swing arm 352 is maintained within a certain range and thus the first tension is maintained within a certain range. For example, the first glass winder 310 may be driven by a servomotor that is controlled by the first tension controller 355. According to some embodiments, to increase the first tension, the first tension control system 350 may further include a weight 353. The weight 353 may increase the first tension by applying an external force to the dancer roller 351 via the swing arm 352.

According to some embodiments, the first tension of the first portion GR1 of the glass ribbon in the first winding zone Z3 may affect a capability of the first glass winding system 300 of uniformly winding the first portion GR1 of the glass ribbon, whereas a second tension of the glass ribbon GR0 in the cutting zone Z2 may affect a speed at which and a quality with which the glass ribbon GR0 is cut. The system 1000 may further include an isolation roller 500 in order to attain both continuous and stable cutting of the glass ribbon GR0 and uniform winding of the first portion GR1 of the glass ribbon. The isolation roller 500 may be configured to isolate the first tension of the first portion GR1 of the glass ribbon in the first winding zone Z3 from the second tension of the glass ribbon GR0 in the cutting zone Z2. Accordingly, the isolation roller 500 may enable the first tension control system 350 to control the first tension to be within a different range from the range of the second tension, and it is possible to prevent control of the first tension from affecting the second tension and thus cutting process. According to some embodiments, the first tension of the first portion GR1 of the glass ribbon in the first winding zone Z3 may be maintained to be less than the second tension of the glass ribbon GR0 in the cutting zone Z2. This is because, when the first tension is greater than or equal to the second tension, the first tension may adversely affect cutting of the glass ribbon GR0.

According to some embodiments, the system 1000 may further include a second tension control system 650 configured to control the second tension of the glass ribbon GR0 in the cutting zone Z2. The second tension control system 650 may attain stable and high-quality cutting by maintaining the second tension within a certain range. The second tension control system 650 may include a second tension sensor configured to sense the second tension of the glass ribbon GR0, and a second tension controller 655 configured to control the second tension according to the sensed second tension. According to some embodiments, the second tension sensor may include a dancer roller 651 movable in the vertical direction (the Z direction) between two guide rollers 730a and 730b, a swing arm 652 attached to the dancer roller 651, and a swing arm position sensor 654 configured to sense a position of the swing arm 652. The dancer roller 651 may move according to the second tension, and the swing arm 652 may rotate or move due to movement of the dancer roller 651. The swing arm position sensor 654 may sense the second tension by sensing a rotation or movement of the swing arm 652. The second tension controller 655 may control a rotation speed of the second glass winder 410, namely, a speed at which the second portion GR2 of the glass ribbon is wound, according to the sensed second tension such that the rotation or movement of the swing arm 652 is maintained within a certain range and thus the second tension is maintained within a certain range. According to some embodiments, to increase the second tension, the second tension control system 650 may further include a weight 653. The weight 653 may control the second tension by applying an external force to the dancer roller 651 via the swing arm 652.

According to some embodiments, the second tension control system 650 may further control a tension of the second portion GR2 of the glass ribbon in the second winding zone Z4. In other words, the tension of the second portion GR2 of the glass ribbon in the second winding zone Z4 may not be isolated from the second tension of the glass ribbon GR0 in the cutting zone Z2. According to some embodiments, the tension of the second portion GR2 of the glass ribbon in the second winding zone Z4 may be substantially the same as the second tension of the glass ribbon GR0 in the cutting zone Z2.

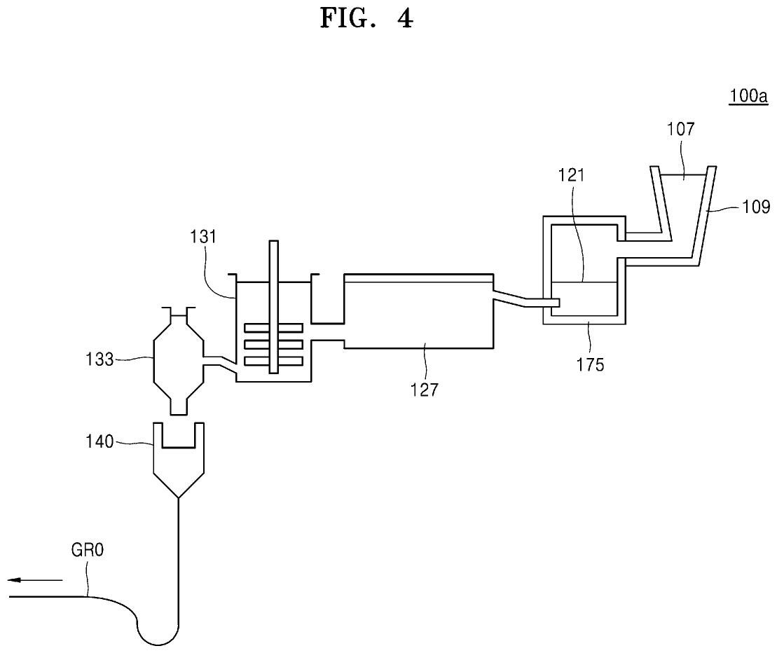

FIG. 4 is a schematic view for explaining a glass ribbon supply system 100a included in the system 1000 of FIGS. 1 and 2 for forming glass rolls according to an embodiment of the present disclosure and used in a method of forming glass rolls according to an embodiment of the present disclosure.

Referring to FIG. 4, the glass ribbon supply system 100a may include a glass ribbon manufacturing system configured to manufacture the glass ribbon GR0 from a glass material 107. In other words, production and cutting of the glass ribbon GR0 and winding of the cut portions GR1 and GR2 of FIGS. 1 and 2 may be continuously and sequentially performed in the system 1000 of FIGS. 1 and 2 for forming glass rolls. The glass ribbon supply system 100a may include a melting vessel 175 melting the glass material 107 to form a melted glass 121, and a forming vessel 140 forming the glass ribbon GR0 from the melted glass 121. According to some embodiments, the glass ribbon supply system 100a may further include a storage and delivery vessel 109 storing the glass material 107 and delivering the stored glass material 107 to the melting vessel 175. The melting vessel 175 may form the melted glass 121 by heating the glass material 107. According to some embodiments, the glass ribbon supply system 100a may further include a fining vessel 127 located downstream of the melting vessel 175. In the fining vessel 127, bubbles may be removed from the melted glass 121. According to some embodiments, the glass ribbon supply system 100a may further include a mixing vessel 131 located downstream of the fining vessel 127. The mixing vessel 131 may reduce non-uniformity within the melted glass 121 by mixing the melted glass 121. According to some embodiments, the glass ribbon supply system 100a may further include a delivery vessel 133 located downstream of the mixing vessel 131 and configured to deliver the melted glass 121 to the forming vessel 140. The delivery vessel 133 may function as an accumulator and/or flow controller for providing the melted glass 121 to the forming vessel 140 with a consistent flow. The forming vessel 140 may form the glass ribbon GR0 from the melted glass 121. Although the forming vessel 140 is of a down draw type in FIG. 4, the forming vessel 140 may be an arbitrary type of forming vessel, for example, a slot draw type forming vessel, a float bath type forming vessel, or an up draw type forming vessel.

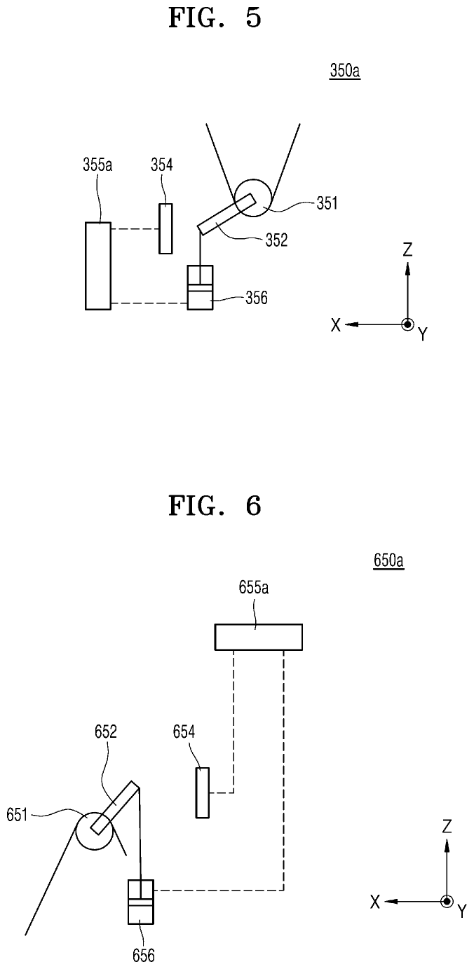

FIG. 5 is a schematic view for explaining a first tension control system 350a included in a system for forming glass rolls according to an embodiment of the present disclosure and used in a method of forming glass rolls according to an embodiment of the present disclosure. FIG. 6 is a schematic view for explaining a second tension control system 650a included in a system for forming glass rolls according to an embodiment of the present disclosure and used in a method of forming glass rolls according to an embodiment of the present disclosure.

Referring to FIG. 5, the first tension control system 350a may include a first tension sensor configured to sense a first tension, and a first tension controller 355a configured to control the first tension according to the sensed first tension, similar to the first tension control system 350 of FIG. 2. Similar to the first tension control system 350 of FIG. 2, the first tension sensor may include a dancer roller 351, a swing arm 352 attached to the dancer roller 351, and a swing arm position sensor 354 configured to sense a position of the swing arm 352. The first tension system 350a may further include a force applying device 356 configured to apply a force to the dancer roller 351 via the swing arm 352. The force applying device 356 may be, for example, a hydraulic device. The first tension controller 355a may control the force applying device 356 according to the sensed first tension.

Similarly, referring to FIG. 6, the second tension control system 650a may include a second tension sensor configured to sense a second tension, and a second tension controller 655a configured to control the second tension according to the sensed second tension. The second tension sensor may include a dancer roller 651, a swing arm 652 attached to the dancer roller 651, and a swing arm position sensor 654 configured to sense a position of the swing arm 652. The second tension system 650a may further include a force applying device 656 configured to apply a force to the dancer roller 651 via the swing arm 652. The force applying device 656 may be, for example, a hydraulic device. The second tension controller 655a may control the force applying device 656 according to the sensed second tension.

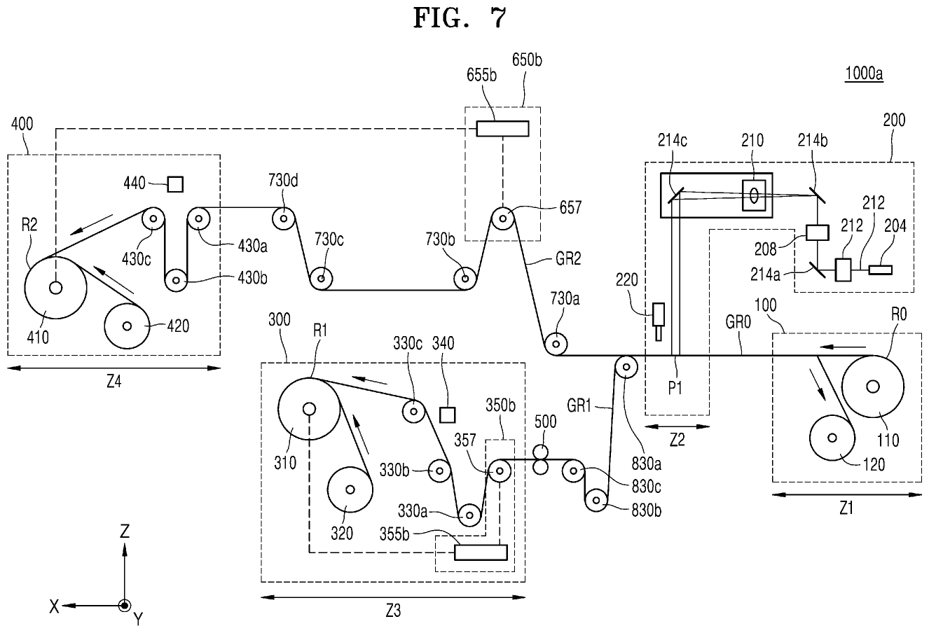

FIG. 7 is a schematic view for explaining a system 1000a for and a method of forming the glass rolls R1 and R2, according to an embodiment of the present disclosure.

Referring to FIG. 7, a first glass winding system 300 may include a first tension control system 350b, and the system 1000a for forming the glass rolls R1 and R2 may include a second tension control system 650b. The first tension control system 350b may include a first tension sensor configured to sense a first tension, and a first tension controller 355b configured to control the first tension according to the sensed first tension. The first tension sensor may include, for example, a load cell roller 357. The first tension controller 355b may control a rotation speed of the first glass winder 310 according to the first tension sensed by the load cell roller 357.

Similarly, the second tension control system 650b may include a second tension sensor configured to sense a second tension, and a second tension controller 655b configured to control the second tension according to the sensed second tension. The second tension sensor may include, for example, a load cell roller 657. The second tension controller 655b may control a rotation speed of the second glass winder 410 according to the second tension sensed by the load cell roller 657.

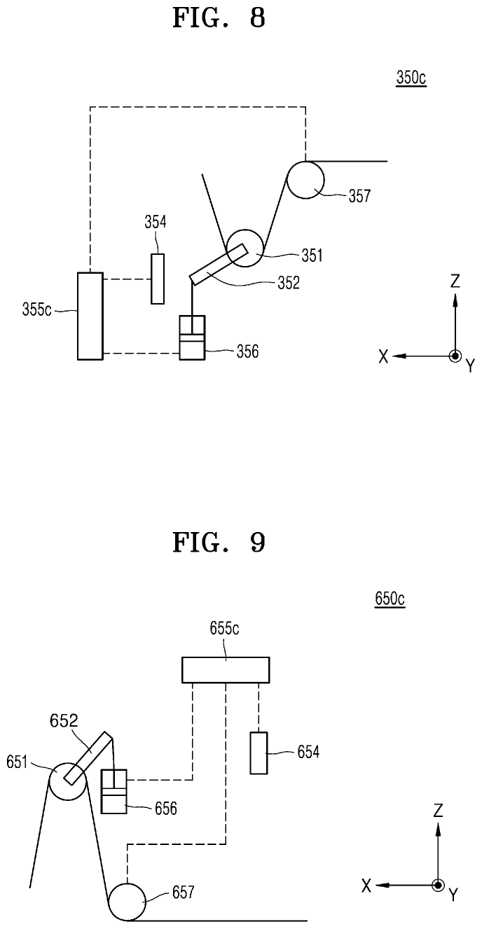

FIG. 8 is a schematic view for explaining a first tension control system 350c included in a system for forming glass rolls according to an embodiment of the present disclosure and used in a method of forming glass rolls according to an embodiment of the present disclosure. FIG. 9 is a schematic view for explaining a second tension control system 650c included in a system for forming glass rolls according to an embodiment of the present disclosure and used in a method of forming glass rolls according to an embodiment of the present disclosure.

Referring to FIG. 8, the first tension system 350c may include both the load cell roller 357 and the dancer roller 351. The load cell roller 357 may sense the first tension and deliver the sensed first tension to a first tension controller 355c. The first tension controller 355c may control the force applying device 356 applying a force to the dancer roller 351 via the swing arm 352 according to the sensed first tension. According to some embodiments, the first tension control system 350c may further include a swing arm position sensor 354 sensing a position of the swing arm 352, and the first tension controller 355c may control the first tension by combining information received from the swing arm position sensor 354 with information received from the load cell roller 357.

Similarly, the second tension system 650c may include both the load cell roller 657 and the dancer roller 651. The load cell roller 657 may sense the second tension and deliver the sensed second tension to a second tension controller 655c. The second tension controller 655c may control the force applying device 656 applying a force to the dancer roller 651 via the swing arm 652 according to the sensed second tension. According to some embodiments, the second tension control system 650c may further include a swing arm position sensor 654 sensing a position of the swing arm 652, and the second tension controller 655c may control the second tension by combining information received from the swing arm position sensor 654 with information received from the load cell roller 657.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

1. A system for forming glass rolls, the system comprising:
a glass ribbon supply system configured to supply a glass ribbon;
a cutting system configured to cut the glass ribbon to a first portion and a second portion;
a first glass winding system configured to wind the first portion of the glass ribbon to form a first glass roll; and
a second glass winding system configured to wind the second portion of the glass ribbon to form a second glass roll.

2. The system of claim 1, wherein the glass ribbon supply system comprises a glass unwinder configured to unwind the glass ribbon from an initial glass roll.

3. The system of claim 1 or 2, wherein the glass ribbon supply system comprises a glass ribbon manufacturing system configured to manufacture the glass ribbon from a glass material.

4. The system of claim 1, wherein the cutting system comprises a laser configured to irradiate the glass ribbon.

5. The system of claim 1, wherein the first glass winding system comprises:
a glass winder configured to wind the first portion of the glass ribbon together with an interleaf to form the first glass roll; and
an interleaf unwinder configured to supply the interleaf to the glass winder.

6. The system of claim 1, wherein the first glass winding system comprises:
a glass winder configured to wind the first portion of the glass ribbon to form the first glass roll;
a position sensor configured to sense a position of the first portion of the glass ribbon; and
a moving device configured to move the glass winder according to the position of the first portion of the glass ribbon.

7. The system of claim 1, wherein the first glass winding system comprises a first tension control system including a first tension sensor configured to sense a first tension of the first portion of the glass ribbon and a first tension controller configured to control the first tension according to the sensed first tension.

8. The system of claim 7, wherein the first tension sensor comprises a dancer roller, a swing arm attached to the dancer roller, and a swing arm position sensor configured to sense a position of the swing arm.

9. The system of claim 7, wherein the first tension sensor comprises a load cell roller.

10. The system of claim 7, wherein the first tension controller is configured to control a rotation speed of a glass winder according to the sensed first tension.

11. The system of claim 7, wherein the first tension controller is configured to control a force applying device configured to apply a force to a dancer roller according to the sensed first tension.

12. A system for forming glass rolls, the system comprising:
a glass ribbon supply system configured to supply a glass ribbon to a cutting zone;
a cutting system configured to cut the glass ribbon to a first portion and a second portion in the cutting zone;
an isolation roller configured to isolate a tension of the first portion of the glass ribbon in a first winding zone from a tension of the glass ribbon in the cutting zone;
a first glass winding system including a first glass winder configured to wind the first portion of the glass ribbon in the first winding zone, and a first tension control system configured to control the tension of the first portion of the glass ribbon in the first winding zone;
a second glass winding system configured to wind the second portion of the glass ribbon in a second winding zone; and
a second tension control system configured to control a tension of the glass ribbon in the cutting zone.

13. The system of claim 12, wherein the tension of the first portion of the glass ribbon in the first winding zone is less than the tension of the glass ribbon in the cutting zone.

14. The system of claim 12 or 13, wherein the second tension control system is further configured to control a tension of the second portion of the glass ribbon in the second winding zone.

15. The system of claim 12, further comprising:
a first guide roller configured to guide the first portion of the glass ribbon downwards; and
a second guide roller configured to guide the second portion of the glass ribbon over the first glass winding system.

16. A method of forming glass rolls, the method comprising
supplying a glass ribbon from a supply zone to a cutting zone;
cutting the glass ribbon to a first portion and a second portion in the cutting zone;
winding the first portion of the glass ribbon to form a first glass roll in a first winding zone; and
winding the second portion of the glass ribbon to form a second glass roll in a second winding zone.

17. The method of claim 16, wherein a width of the first portion of the glass ribbon is greater than 50 mm and less than 320 mm.

18. The method of claim 16, wherein a thickness of the glass ribbon is 0.05 mm to 0.3 mm.

19. The method of any claim 16, wherein the winding of the first portion of the glass ribbon is performed during the winding of the second portion of the glass ribbon.

20. The method of claim 16, wherein the providing of the glass ribbon comprises unwinding the glass ribbon from an initial glass roll.

21. (canceled)

22. (canceled)

23. (canceled)

24. (canceled)

25. (canceled)

26. (canceled)

27. (canceled)

28. (canceled)

29. (canceled)

30. (canceled)
